(19) United States
(12) Patent Application Publication
(10) Pub. No.: US 2006/0231044 A1
(43) Pub. Date: Oct. 19, 2006

(54) APPARATUS AND METHOD FOR ORALLY MEDICATING EQUINES

(76) Inventor: Alyssa Larson, Hanna, AB (CA)

Correspondence Address: SANDER R. GEISING, 600, 4911-51 STREET, RED DEER, AB, T4N-6V4, CA

(21) Appl. No.: 11/279,875

(22) Filed: Apr. 14, 2006

(30) Foreign Application Priority Data
Apr. 14, 2005 (CA) 2504081

(51) Int. Cl. A61D 7/00

(52) U.S. Cl. 119/833

(57) ABSTRACT

An apparatus for orally administering medication to an animal is disclosed. The apparatus comprises a tubular member having a mouth portion, an exterior portion, an inlet on the exterior portion and an outlet on the mouth portion, said inlet and outlet being in fluid communication. The apparatus preferably comprises slidably adjustable securing means for securing the apparatus to the animal. A method aspect is also provided. Preferably, during operation the inlet is positioned outside the animal's field of vision, so that the oral medication can be inserted into the apparatus, and administered to the animal, without the animal being aware.

### FIELD OF THE INVENTION

The present invention relates to an apparatus and method for medicating animals and livestock and, more particularly, to an apparatus and method for orally administering liquid and semi-solid medication to equines and the like.

### BACKGROUND OF THE INVENTION

There are more than 150 internal parasites that afflict horses; therefore deworming is an essential element of caring for a horse's health. Some species of parasites can lay more than 200,000 eggs a day so parasite loads can grow quickly. Parasites can harm horses in many different ways including damage to major blood vessels, intestines, lungs, liver and stomach. They may also cause obstructions or ulcerations within the digestive tract of the horse.

Deworming schedules vary depending on the horse's age or situation. For example, young foals are especially susceptible to roundworm infestation and may require deworming as frequently as every thirty days. A minimum deworming schedule is typically twice a year.

When deworming, it is advantageous that the product is given in the proper dosage (typically calculated based on a horse's weight) and that it is fully consumed and contained by the animal at the time of deworming. It is also advantageous to deworm all the horses on a single property at the same time.

There are currently three primary ways to administer deworming medication. They are:

1. oral paste, gel or liquid;

2. nasogastric tube (tubing); and

3. feed additive

Although all three methods of deworming are typically effective, they all have distinct disadvantages.

Deworming pastes and gels come ready packaged in a disposable syringe and are administered orally. The liquid is also administered orally, typically via a syringe as well. However, horses often dislike the product and will typically spit out a good portion of it. It is difficult to measure the amount spit out by the horse and a horse can therefore end up with an incorrect dosage of dewormer.

Furthermore, horses and other animals, after being medicated a few times, will typically recognize when another oral treatment will be administered, will back away from the person with a syringe containing the oral medication, thereby making subsequent oral administrations more difficult. Some horses will even rear and strike out with their front legs when a person attempts to administer the oral medications, thereby creating a danger and perhaps requiring veterinarian sedation prior to administration of such medication (adding to the overall cost of treatment).

Food additives or formulations are an appropriate choice only if it can be ensured that the horse will ingest the entire dose. When treating multiple horses with a feed formulation one is required to watch each animal to ensure that it has eaten the entire product. The animals will typically have to be kept separate from each other at the time of deworming to ensure that the dosage required was not consumed by another horse. As well, many horses will reject feed that has a deworming additive.

Deworming using a nasogastric tube ensures that the proper dose is delivered. Unfortunately because of the skill required to insert the tube safely, this method is generally performed by a veterinarian only. This is a distinct disadvantage to the horse owner as cost could be astronomical. This method also causes some temporary discomfort to the horse when the tube is passed through the nostrils and down the esophagus to the stomach.

What is desired therefore is an apparatus and method which overcomes the limitations and problems of the prior art.

### SUMMARY OF THE INVENTION

The invention provides an apparatus for orally administering medication to an animal. In one aspect, the apparatus comprises, a tubular member having a mouth portion, an exterior portion, an inlet on the exterior portion and an outlet on the mouth portion, said inlet and outlet being in fluid communication. The apparatus further comprises securing means for securing the apparatus to the animal. Preferably, said securing means are slidable mounted to the tubular member. More preferably, the exterior portion is of sufficient length to allow the inlet to be positioned outside of the animal's field of vision when the apparatus is secured to the animal.

In a method aspect the invention comprising the steps of providing an oral medication apparatus having securing means and a tubular member, said tubular member having a mouth portion, an exterior portion, an inlet on the exterior portion and an outlet on the mouth portion, said inlet and outlet being in fluid communication, inserting the mouth portion into the mouth of the animal, securing the apparatus to the animal using the securing means, and inserting the oral medication into the inlet.

Advantages of the present invention include:
the medication is administered quickly and effectively;
dosage calculations are easy to determine;
little or no discomfort to the animal;
apparatus is easy to operate;
apparatus provides the operator with greater control over the animal during administration of oral medications than prior art devices and methods;
veterinarian sedation of the animal is typically not required;
the apparatus can be used to administer medication before an animal knows what is coming, thereby reducing incidents of animals associating the device with being medicated;
the apparatus is simple in design; and
the apparatus can be manufactured for minimal cost.

### BRIEF DESCRIPTION OF THE DRAWINGS

FIGS. 1-2 are perspective views of one embodiment of the present invention;

FIGS. 3-6 are perspective views of the embodiment of FIGS. 1 and 2 secured to, or fastened on, the head or neck of an animal, in this case a horse;

FIGS. 7-9 are perspective views of the embodiment of FIGS. 1 and 2 secured to, or fastened on, the head or neck of an animal and liquid medication being administered to the animal through the apparatus;

FIG. 10 is a perspective view of a second embodiment of the invention; and

FIGS. 11-24 are various views of a third embodiment of the invention.

### DETAILED DESCRIPTION OF THE PREFERRED EMBODIMENTS

Reference is to be had to the Figures in which identical reference numbers identify similar components.

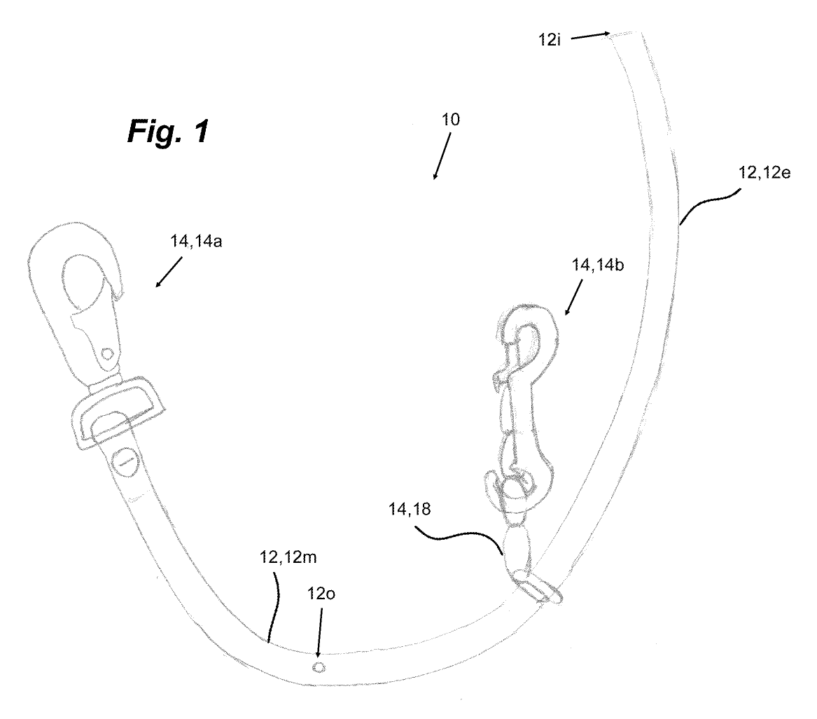

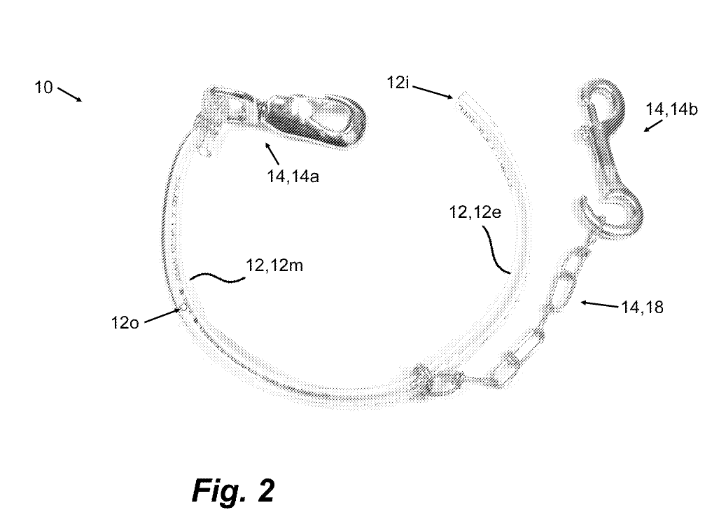

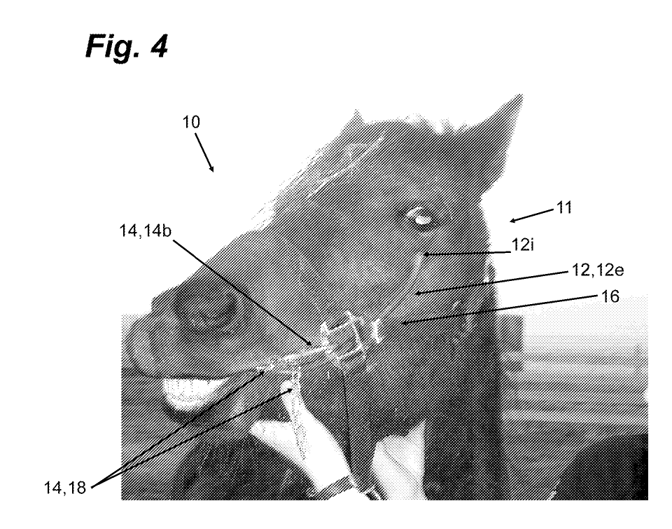

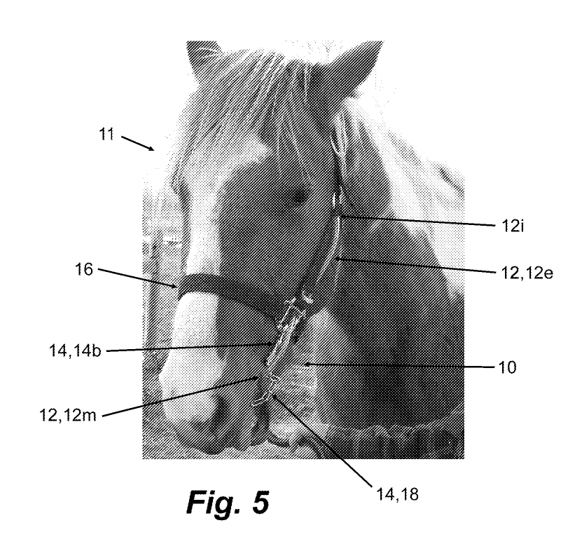

Referring to FIGS. 1-9, a first embodiment of an apparatus 10 for inserting, giving or dispensing oral medication into an animal 11 is show. For illustration purposes a horse is shown, but those skilled in the art will recognize that the apparatus 10 may be used to give oral medication to a variety of animal species.

The apparatus 10 comprises a tubular member 12 having a mouth or oral portion 12m, at least one exterior or non-oral portion 12e, at least one inlet 12ion the exterior portion 12e and at least one Preferably the inlet 12i and outlet 12o are simple holes or openings in the tubular member 12. More preferably, the end 12c of tubular member 12 opposite the inlet 12i is closed or sealed.

The mouth portion 12m is in fluid communication with the exterior portion 12e so that a paste, liquid or fluid oral medication 13, which may be inserted into the inlet 12i, can travel from the inlet 12i through the exterior portion 12e to the mouth portion 12m and out the outlet 12o. The mouth portion 12m is adapted or configured to be placed inside the mouth of the animal 11. Preferably the tubular member 12 is made from a flexible see-through plastic to allow one to see the progression of the medication 13 through the apparatus 10 and to facilitate placement of the inlet 12i outside the animal's field of vision (by manipulating or twisting the exterior portion 12e as may be required. Other suitable materials for the tubular member 12 include rubber or opaque flexible plastics.

The apparatus 10 further comprises securing means 14 for securing the apparatus 10 to the animal 11 during operation. Preferably the securing means 14 attaches or secures the apparatus 10 to the head or neck of the animal 11 or to another device 16, such as a halter 16h, which is already fastened on the head or neck of the animal 11. More preferably, the securing means 14 are adjustable so as to accommodate various species, sizes and ages of animals.

In the first embodiment of the apparatus 10, the securing means 14 secures the apparatus 10 to another device 16, such as a halter 16h, which is already fastened on the head or neck of said animal 11; and said securing means 14 further comprises a pair of snaps or clips 14a, 14b and a tensile connector such as a strap or length of chain 18. The snaps 14a, 14b clip or snap onto said device or halter 16.

In the first embodiment of the apparatus 10, one of the snaps 14a is preferably mounted to one end 12c of the tubular member 12, near the mouth portion 12m. The other snap 14b is preferably attached to a length of chain 18. The length of chain 18 slidably mounts over the other end of the tubular member 12 nearer the inlet 12i, said chain 18 slidably adjustable along or over the tubular member 12. Preferably, the chain 18 has links of such interior diameter or spacing that it can be slidably mounted over or around the tubular member 12 and can be secured at a particular relative position by means of a friction fit. More preferably, said snap 14b is an open-ended hook-type snap, able to hook onto the chain 18 at any of the chain's links. Advantageously, by slidably adjusting the chain 18 relative to the tubular member 12 and by hooking the open-ended snap 14b on an appropriate link of the chain 18, the apparatus 10 may be used on a range of different sized animals.

Method:

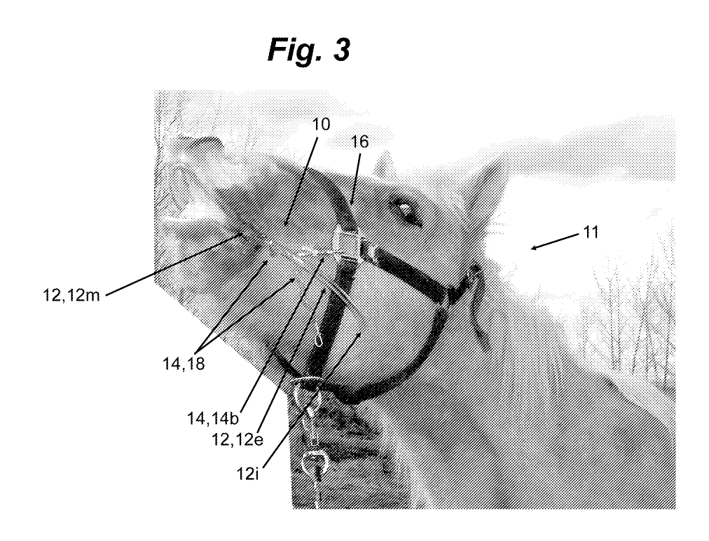

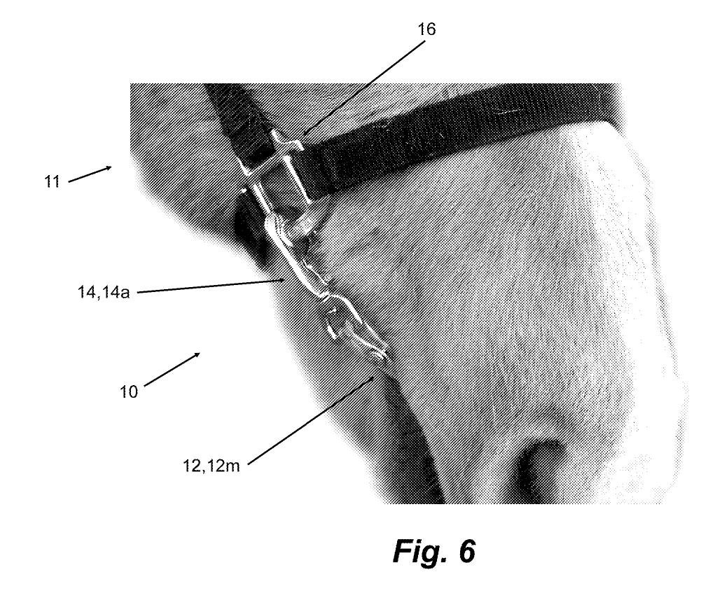

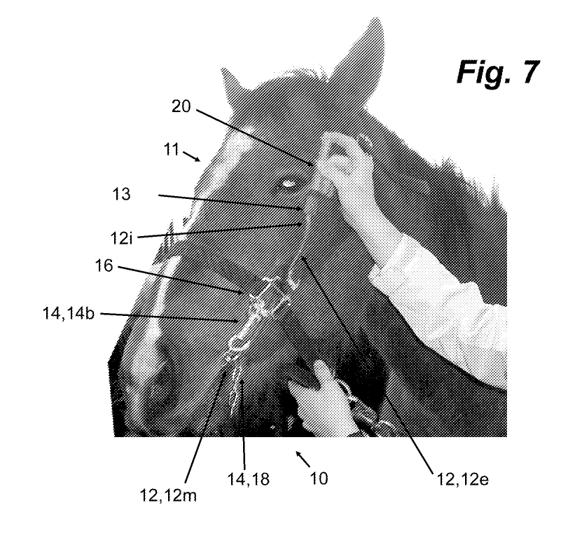

Referring to the FIGS. 3-9, one embodiment of a method aspect for administering oral medication 13 to an animal 11 wearing a halter 16h, and using the apparatus 10 is shown. The method comprises the following steps:
securing the apparatus 10 to one side of the head of the animal 11 by clipping snap 14a onto the halter (see FIG. 6);
clipping open-ended snap 14b onto the halter at the other side of the animal's head (see FIGS. 3 and 7);
inserting the mouth portion 12m of the tubular member 12 into the mouth of the animal 11;
attaching the open end of snap 14b to the chain 18;
and
inserting liquid medication 13 into the inlet 12i (see FIGS. 7-9).

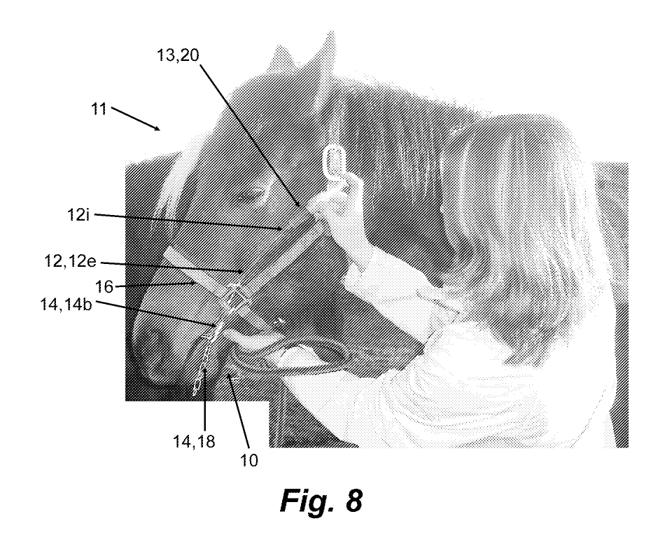

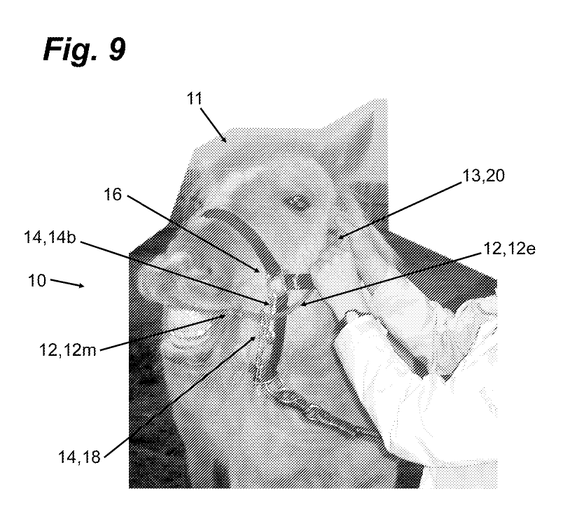

Preferably the method further comprises slidably adjusting the chain 18 along the tubular member 12, so as to adjust the apparatus 10 for a proper fit. More preferably the method further comprises adjusting the tubular member 12 and securing means 14 to ensure that the outlet 12o is substantially centered in the animal's mouth. Even more preferably the method further comprises positioning the external portion 12e and inlet 12i close to the side of the animal's head, away from the mouth of the animal 11 and outside the animal's field of vision (see FIGS. 8 and 9).

Advantageously, and because horses are generally accustomed to having tubular or bit-like devices in their mouths, the insertion of the mouth portion 12m into the mouth of a horse will usually not cause a particular animal to associate the apparatus 10 with the administration of the medication 13. More advantageously, by positioning the external portion 12e and inlet 12i outside the animal's field of vision, medication 13 can be administered before the animal 11 knows or realizes what is coming and it will be less likely to associate the person administering the medication 13 as being the source of the medication 13, thereby reducing incidents of future difficulties, such as rearing. Even more advantageously, once the external portion 12e and inlet 12i are positioned outside the animal's field of vision, a syringe or other source of medication 13 may be brought up to, and connected with, the inlet 12i in a manner so that the animal will never see it.

Other Embodiments

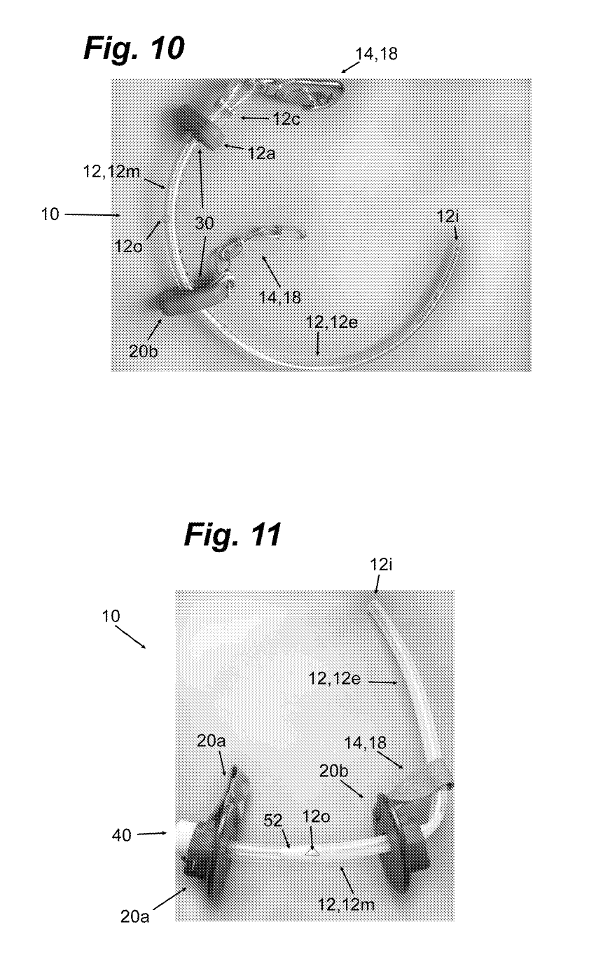

Referring now to FIG. 10, a second embodiment of the apparatus 10 is shown. This embodiment is similar to the first embodiment of FIGS. 1-9 and further comprises a pair of guards 20a, 20b slidably mounted over the tubular member 12. Preferably, the guards 20a, 20b have an interior passage 30 of such dimensions so that they can be slidably mounted over or around the tubular member 12 and can be secured at particular relative positions by means of a friction fit. One of the guards 20a is generally mounted between snap 14a and the mouth portion 12m and the other guard 20b generally mounted over the tubular member between the mouth portion 12m and inlet 12i. Preferably, the guards 20a, 20b are of such external dimensions and shape so as to ensure that the tubular member 12 will not be pulled too far into the mouth of the animal 11 as the member 12 is secured onto the animal 11 or device 16 via the securing means 14.

Further, in this embodiment, the tensile member 18 is attached to guard 20b, rather than slidably over the tubular member 12. However, since the guards 20a, 20b both are slidably mounted over the tubular member 12, the apparatus 10 can still be adjusted for a proper fit on a particular animal 11.

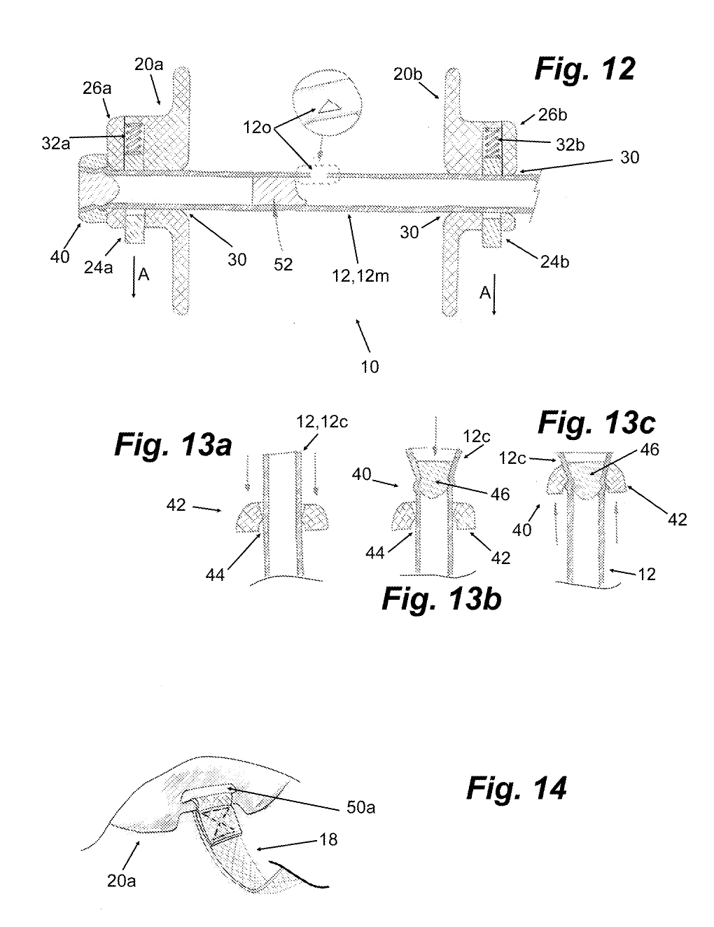

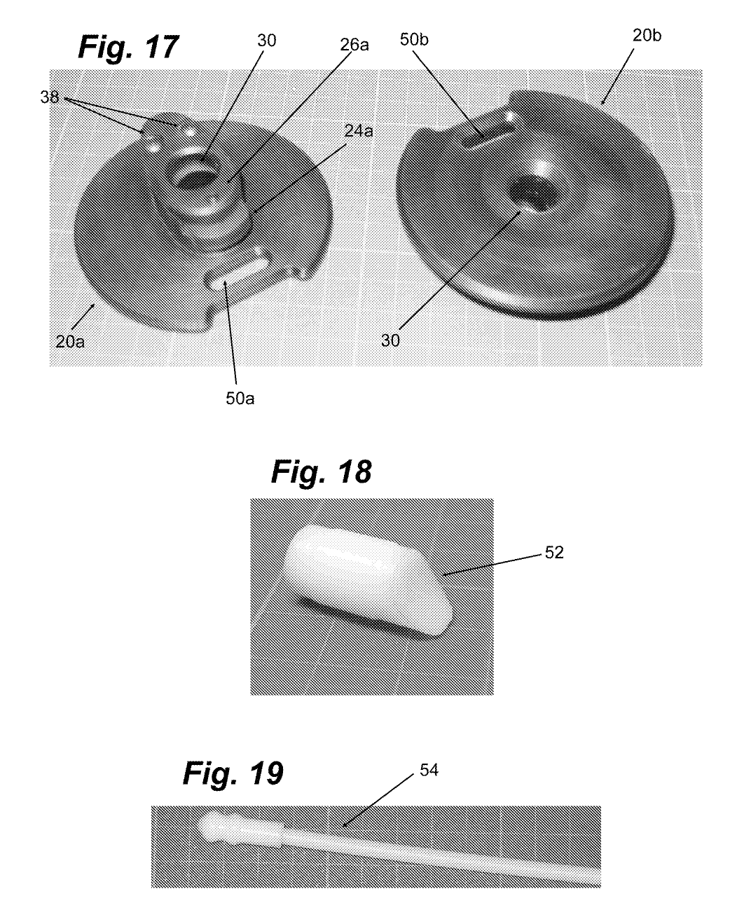

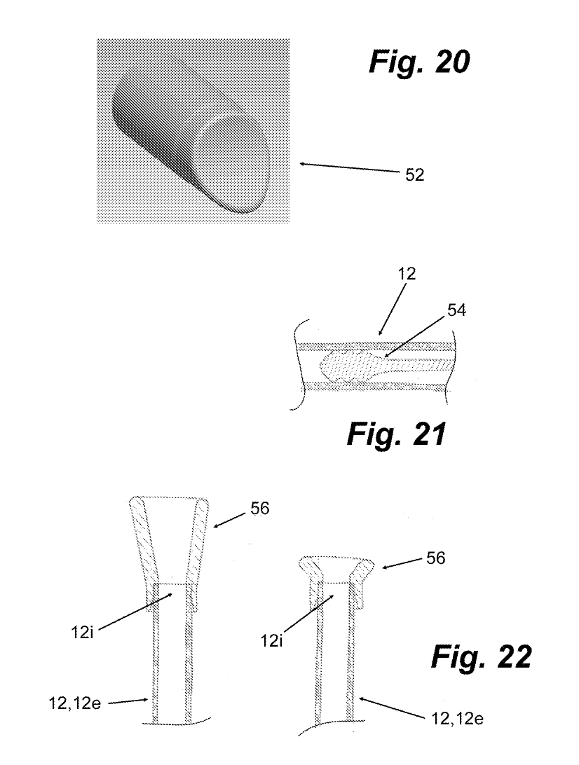

In FIGS. 11-24 a third embodiment of the apparatus 10 is shown. This embodiment is similar to the second embodiment of FIG. 10. In this embodiment, the pair of guards 20a, 20b are slidably mounted over the tubular member 12 and each of the guards 20a, 20b further comprise a friction member 24a, 24b that is slidably mounted against the respective guards 20a, 20b and retaining members 26a, 26b. The retaining members 26a, 26b keep the friction members 24a, 24b slidably mounted against or on the guards 20a, 20b as shown in FIGS. 12,16 and 17. The guards 20a, 20b, the friction members 24a, 24b and the retaining members 26a, 26b all have a passage 30 of sufficient diameter to accept the tubular member 12 therethrough, as more clearly shown in FIGS. 12 and 24.

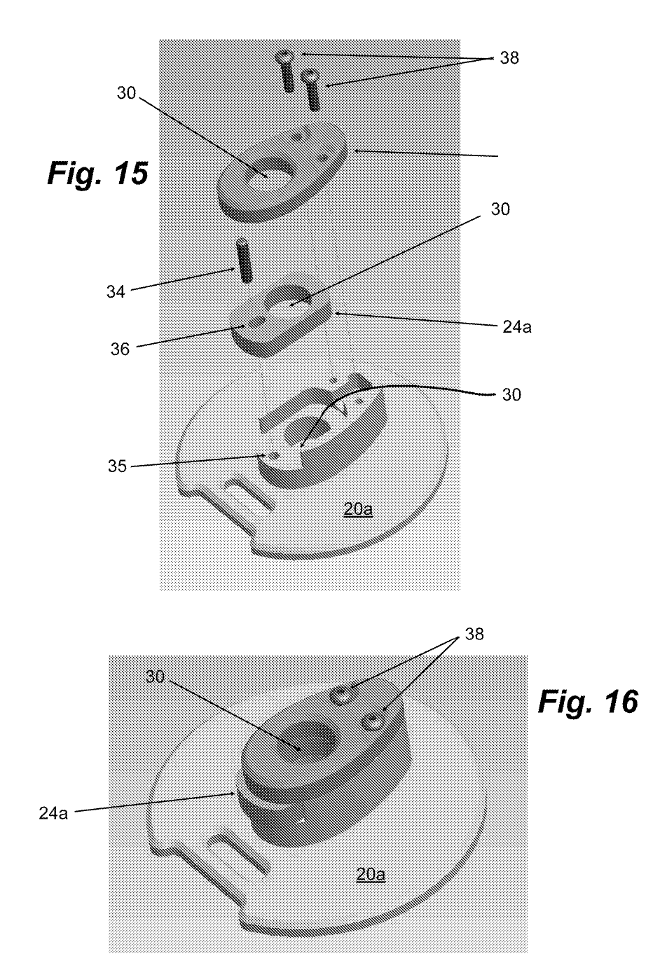

In this embodiment, the guards 20a, 20b further comprise springs 32a, 32b which bias the friction members 24a, 24b axially relative to the guards 20a, 20b, generally in the direction indicated by arrow A (see FIG. 12). Preferably, pins 34 mount in appropriate recesses 35 in the guards 20a, 20b and in the retaining members 26a, 26b and through an oval passage 36 in the members 24a, 24b; as better shown in FIG. 15. More preferably, screws 38 facilitate the assembly of the guards 20a, 20b, the friction members 24a, 24b, the retaining members 26a, 26b, the springs 32a, 32b and the pins 34 into an assembled unit, as more clearly shown in FIG. 16.

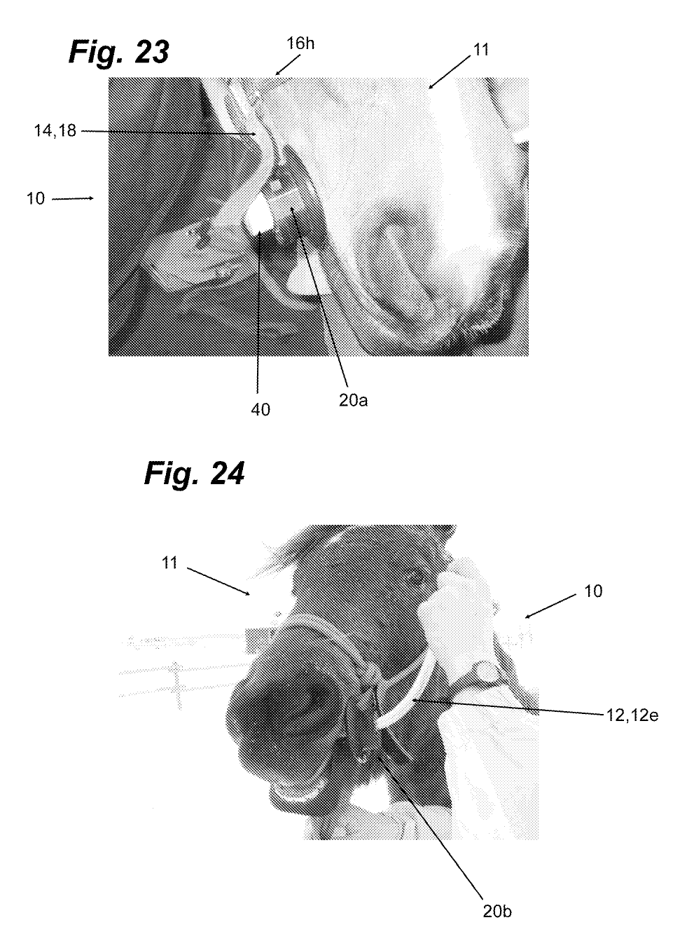

This embodiment of the apparatus 10 further comprises stopper means 40 that is mountable on the end 12c of the tubular member 12 opposite the inlet 12 (see FIGS. 13 and 23). In this embodiment the stopper means 40 comprises a outside member 42, having a passage 44 of sufficient diameter to slide just over the tubular member 12, and a wedged shaped inside member 46 that is inserted into the tubular member's end 12c. The stopper means 40 can be securely mounted on the end of the tubular member 12c by passing the outside member 42 over the end 12c some distance (see FIG. 13a), inserting the inside member 46 into the end 12c (see FIG. 13b) and pulling the outside member 42 back and over top of the inside member 46 (see FIG. 13c), snapping both pieces 42, 46 together and pinching the end 12c of the tubular member 12 thereby securely fastening the stopper means 40 at the end 12c. The stopper means 40 is of sufficient size to prevent a guard 20afrom being slid past. Advantageously, the stopper means 40 functions to provide additional security to the apparatus 10 (see FIGS. 12 and 23).

Additionally, in this embodiment, the tensile member 18 is a strap and is attached to guards 20a, 20b through oval openings 50a, 50b (see FIG. 14). Preferably, the apparatus 10 further comprises a plug 52 suitable for plugging the inside diameter of the tubular member 12 and is positionable downstream from the outlet 12o (as shown in FIG. 12) so as to direct medication 13 from the exterior portion 12e out the outlet 12o. Even more preferably, the apparatus 10 further comprises a plunger 54 to assist in moving medication 13 (such as paste) through the tubular member 12 and out the outlet 12o (see FIGS. 19 and 21). Yet even more preferably, the apparatus 10 further comprises a funnel member 56 that is slidable over the inlet 12i of the tubular member 12 and facilitate insertion of the medication into the tubular member 12 (as more clearly shown in the two funnel embodiments in FIG. 22).

In another embodiment (not shown), the securing means 14 comprise a pair of Velcro™ type straps which can be removably secured to a halter 16h or similar device. In yet another embodiment (not shown), the securing means 14 secures the apparatus 10 directly to the head or neck of an animal via Velcro™ type straps.

Preferably, during operation and when the apparatus 10 is secured to the animal 11, the inlet 12i will be oriented or located above the outlet 12o so that any liquid or fluid medication 13 inserted into the inlet 12i will travel from the inlet 12i through the exterior portion 12e to the mouth portion 12m and out the outlet 12o by gravity. The liquid medication 13 may be inserted into the inlet 12i by a number of means, including using a funnel 56 or a syringe 20 (see FIGS. 7-9). In another embodiment, the inlet 12i is of such diameter and material so as to sealably receive a syringe 20, said syringe 20 then being employed to force the liquid medication 13 from the inlet 12i through the exterior portion 12e to the mouth portion 12m and out the outlet 12o by hydraulic action (the relative location of the inlet 12i compared to the outlet 12o then not being of importance).

In another embodiment (not shown) the apparatus 10 further comprises a plurality of outlets 12o on the mouth portion 12m. In yet another embodiment (not shown) the apparatus 10 further comprises a plurality of exterior portions 12e each having an inlet 12i and a plurality of mouth portions 12m each having an outlet 12o, wherein each exterior portion 12e and inlet 12i pair is in fluid communication only with one of the mouth portion 12m and outlet 12o pairs, and said mouth portions 12m are not in fluid communication with each other. Advantageously, this latter embodiment will allow for two different oral mediations 13 to be administered to the animal 11 simultaneously, or one after the other, without mixing or contaminating.

In yet another embodiment (not shown) the apparatus 10 does not have an outlet 12o, but rather comprises a dissolvable mouth portion 12m which is in fluid communication with the exterior portion 12e and inlet 12i. As the mouth portion 12m is dissolved any medication residing in it is then administered to the animal. Advantageously, such a dissolvable mouth portion 12m can be used to administer medication on time release basis.

It will be appreciated by those skilled in the art that the apparatus 10 and method described above are not limited to be used for administering oral deworming medication to horses, but that said apparatus 10 and method may be used to administer any oral medication (or any paste, liquid or fluid for that matter) to a great variety of animals.

1. An apparatus for orally administering medication to an animal, the apparatus comprising:
a tubular member having a mouth portion, an exterior portion, an inlet on the exterior portion and an outlet on the mouth portion, said inlet and outlet being in fluid communication; and
securing means for securing the apparatus to the animal.

2. The apparatus of claim 1 wherein the securing means are slidably mounted to the tubular member.

3. The apparatus of claim 2 wherein the securing means further comprises a chain having at least one link with an interior diameter to allow said chain to slidably mount over the tubular member 12 and remain at selected position along the tubular member by means of a friction fit.

4. The apparatus of claim 1 wherein the exterior portion is of sufficient length to allow the inlet to be positioned outside of the animal's field of vision when the apparatus is secured to the animal.

5. The apparatus of claim 3 wherein the exterior portion is of sufficient length to allow the inlet to be positioned outside of the animal's field of vision when the apparatus is secured to the animal.

6. The apparatus of claim 1 further comprising at least one guard slidably mountable over the tubular member.

7. The apparatus of claim 6 wherein the securing means further comprises a tensile member connected to the guard.

8. A method for administering oral medication to an animal, the method comprising the steps of:
providing an oral medication apparatus having securing means and a tubular member, said tubular member having a mouth portion, an exterior portion, an inlet on the exterior portion and an outlet on the mouth portion, said inlet and outlet being in fluid communication;
inserting the mouth portion into the mouth of the animal;
securing the apparatus to the animal using the securing means; and
inserting the oral medication into the inlet.

9. The method of claim 8 further comprising the step of positioning the inlet outside the animal's field of vision, prior to inserting the oral medication into the inlet.
